(19) United States
(12) Patent Application Publication
(10) Pub. No.: US 2025/0355162 A1
(43) Pub. Date: Nov. 20, 2025

(54) THERMAL EXPANSION-BALANCED TRANSVERSE ANDERSON LOCALIZATION OPTICAL WAVEGUIDES THAT HAVE REDUCED BOWING

(71) Applicants: SCHOTT AG, Mainz (DE); SCHOTT NORTH AMERICA, INC., New York, NY (US)

(72) Inventors: Andrea RAVAGLI, New York, NY (US); Andreas KOGLBAUER, Mainz (DE); James MARRO, Duryea, PA (US); Hubertus RUSSERT, Mainz (DE); Kevin TABOR, Southbridge, MA (US)

(73) Assignees: SCHOTT AG, Mainz (DE); SCHOTT NORTH AMERICA, INC., New York, NY (US)

(21) Appl. No.: 18/871,667

(22) PCT Filed: Jun. 9, 2023
(86) PCT No.: PCT/EP2023/065503

§ 371 Date: Dec. 4, 2024

(30) Foreign Application Priority Data
Jun. 13, 2022 (US) 63366258

(51) Int. Cl. G02B 6/08

(52) U.S. Cl. CPC G02B 6/08

(57) ABSTRACT

The invention relates to thermal expansion-balanced transverse Anderson localization optical waveguides that have reduced bowing. The optical waveguide is formed of a fiber bundle comprising at least two distinct structural elements. The low curvature of the waveguide is achieved by a net CTE modulus being close to zero, which is achieved by relocating some of the structural elements of the fiber bundle to a different quadrant of the waveguide cross-section.

The invention relates to thermal expansion-balanced transverse Anderson localization optical waveguides that have reduced bowing for transmitting electromagnetic waves, in particular for transmitting image information, and to methods of manufacturing waveguides, in particular image guides.

Image guides typically comprise a plurality of individual optical fibers, each of which comprises a core and a cladding surrounding the core, the optical fibers being assembled as a bundle and arranged in cross-section in a grid with a one-to-one relationship between the light input surface and the light output surface to form a plurality of pixels. Basically, each pixel serves to transmit a brightness value or color information via the image guide.

In practice, it is often desirable to have the highest possible resolution of the image guide. In principle, a high resolution can be achieved by reducing the diameter of the individual optical waveguides. However, due to physical laws, the resolution cannot be increased linearly because, as the diameters of the individual optical waveguides become smaller and smaller, an increasing proportion of the field distribution of the transmitted modes exceeds the dimensions of the optical waveguides, in particular the cladding, which leads to increased crosstalk between adjacent optical waveguides and thus to increasing blurring.

One approach to provide image guides with higher resolution is based on the wave phenomenon of transverse Anderson localization (TAL). This takes advantage of the fact that a random distribution of refractive indices over the cross-section of the image guide with simultaneous invariance of the refractive indices for each fiber along the length of the image guide leads to a limitation of the coupled light in the cross-section due to destructive interference. In practice, for example, a large number of individual fibers with different refractive indices can be combined to form a transverse Anderson localization optical waveguide. If a light beam is coupled into such a waveguide, it propagates along the length of the waveguide with a transverse extension limited in cross-section.

On the one hand, image guides based on the principle of transverse Anderson localization allow higher resolutions; on the other hand, the random distribution of the refractive indices may lead to the disadvantage that the image quality, in particular the image sharpness, of the transmitted image information is subject to local fluctuations or can be difficult to control. For example, the image sharpness in certain areas of the cross-section may deviate from the image sharpness in other areas of the cross-section.

Such inhomogeneities make it difficult in practice to produce image guides with a certain quality standard. Depending on the quality criteria applied to production, a high level of rejects can occur. The above-mentioned problems may become even more acute if the cross-sectional area of the image guide is to have large dimensions. This applies in particular to faceplates, where the edge length or the diameter of the cross-section sometimes exceeds the thickness of the faceplate many times over.

In addition, the disorder necessary to ensure a high optical performance of the image guide may have repercussion on other physical properties of the waveguide. For example, the waveguide can often have bowed fibers after stretching during the fiber drawing process or even after the fiber bundle is produced. This may result in a number of issues, such as:
1) The curvature can decrease the optical properties of the waveguide. In particular, it can increase the level on noise in the transmitted signal, thereby decreasing the signal quality and the image quality;
2) The fiber may be more likely to undergo a mechanical failure for being under constant tensile stress in one of the edges; and
3) The fibers may be difficult to handle and be less robust and it is not always possible to align bowed fibers into optical fiber bundles.

A faceplate is a type of waveguide that is typically understood to be a group of often relatively short (for example a few mm), fused optical fibers whose axes are perpendicular to the faceplate surface that has a cross-sectional area which may be a few mm² to many cm². The central property of faceplates is to enable image transmission, identically in strict order, i.e. 1:1, or varied according to a rule, e.g. rotated, from one faceplate surface to the opposite faceplate surface.

Accordingly, it is an object of the invention to provide waveguides, in particular image guides, as well as methods for the production thereof, which achieve an increased homogeneity, in particular an increased image sharpness, over the cross-section of the waveguides. One aspect of the task of the invention is to make the homogeneity over the cross-section more controllable, and reproducible, for example in order to avoid rejects during production and to be able to consistently manufacture waveguides that achieve certain quality standards. Another aspect of the invention is to reduce the amount of bowing.

One aspect of the task of the invention is to be able to provide waveguides, in particular image guides, with large cross-sectional areas, using Anderson localization which at the same time comply with the aforementioned conditions, in particular a defined homogeneity. This relates in particular to waveguides formed as faceplates.

The present invention discloses waveguides for transmitting electromagnetic waves using Anderson localization, in particular for transmitting image information from a proximal end of the waveguide to a distal end of the waveguide, along a transport direction extending between the proximal and distal ends, wherein the waveguide comprises a fiber bundle extending along the transport direction and comprising a first structural element and a second structural element that differs from the first structural element. In some embodiments, the first structural element and the second structural element have different refractive indices with or without different cross-sectional areas. The fiber bundle may have a bowing radius (also referred to herein as an “curvature”) of 0.1 meters⁻¹ or less and a Net CTE Modulus of 0.01 ppm/K or less.

At least two different types of structural elements can be used, namely a first type having a first refractive index and a second type having a second refractive index which is different than the first refractive index. Accordingly, the plurality of structural elements may comprise at least one structural element of the first type as well as at least one structural element of the second type. Of course, also more than two different types, e.g. three different types of structural elements may be used.

The structural elements can each extend along the transport direction as well as over the cross-section of the waveguide in such a way that a plurality of cross-sectional regions is defined in the cross-section of the waveguide, each corresponding to the cross-section of a single structural element. Accordingly, the structural elements can extend side by side, in particular parallel to one another, along the transport direction of the waveguide and their cross-sections can each occupy a planar portion of the cross-section of the waveguide and therefore can each define a cross-sectional region of the cross-section of the waveguide. The cross-sectional regions can thus correspond in particular to the surface regions formed by the structural elements when looking at a cross-sectional surface of the waveguide, for example the light entry or light exit surface.

According to some embodiments of the invention, the first structural element may differ from the second structural element by its refractive index, cross-sectional area and/or composition.

In some embodiments, the physical arrangement of each structural element in relation to the others is mathematically determined during manufacture of the waveguide so that the fiber bundle has a Net CTE Modulus of 0.01 ppm/K or less.

The cross-sectional regions of the structural elements may have geometries which are non-uniform with respect to one another, for example non-uniform diameters. However, the geometries of the cross-sectional regions can also be of the same type. In addition, a waveguide that is comprised of plurality of optical fiber bundles that are fused together can be twisted (e.g. inverted) about the central axis of the waveguide to form an inverted waveguide for non-limiting example as disclosed in U.S. Pat. No. 11,079,538, the entire contents of which are hereby incorporated by reference.

In some embodiments, each fiber has a diameter, and the fiber diameter varies as function of a fiber's radial displacement from the central bundle axis, for non-limiting example as disclosed in U.S. Pat. No. 11,079,538, the entire contents of which are hereby incorporated by reference.

The structural elements can be arranged in such a way that electromagnetic waves transmitted by the waveguide remain localized in a direction extending transversely to the transport direction, and at the same time bowing of the fibers during the fiber drawing process can be reduced. Bowing is when the fiber bundle curves along its length. In particular, the curvature can increase the level on noise in the transmitted signal and decrease the signal quality and the image quality. Also, the curvature makes the structural element more likely to undergo a mechanical failure since the structural element is under constant tensile stress in one of its edges. The curvature also makes the structural element difficult to handle and to incorporate into a bundle of structural elements.

The structural elements can be arranged mathematically in such a way that the waveguide has a reproducible structure, in particular in such a way that further waveguides with a structure identical or substantially similar to the waveguide can be produced.

One way to produce a fiber bundle that minimizes bowing and has other advantages is to arrange the first and second structural elements during manufacture of the fiber bundle so that the fiber bundle has a Net CTE Modulus of 0.01 ppm/K or less. This value is mathematically calculated as described herein. An individual fiber bundle having a Net CTE Modulus within this range is considered to be “balanced” in terms of CTE, and since such an individual bundle is balanced, a waveguide that is formed by fusing many such balanced fiber bundles will itself be balanced.

The ratio of the total area of the cross-sectional regions of the first structural elements to the total area of the cross-sectional regions of the second structural elements can be, for example, in a range between 1:150 and 150:1, 1:100 and 100:1, 1:50 and 50:1; 1:10 and 10:1, 3:7 and 7:3, 4:6 and 6:4, or 5:5. This can also be understood as a degree of filling.

The refractive index of the first structural elements and the refractive index of the second structural elements may differ by at least 10-4, for example by at least 10-3, for example by at least 10-2, for example by at least 10-1, for example by at least 1, for example by at least 2, for example by at least 3, for example by at least 4.

With respect to the lateral extent of the structural elements, it may be provided that at least one cross-sectional region has a minimal transverse extent of 100 nm to 50 μm, 400 nm to 20 μm, or 1 μm to 16 μm.

Furthermore, it can be provided that at least one cross-sectional region has a diameter which lies between 0.1 times and 10 times the average wavelength, in particular of a wavelength range of electromagnetic waves to be preferably transmitted, between 0.2 times and 5 times the average wavelength, or between 0.5 times and 2 times the average wavelength.

With respect to the geometric shape of the structural elements, it may be provided that the structural elements have a non-circular or polygonal geometry, for example pentagonal or hexagonal.

The first structural elements can be in particular formed as a, for example monolithic, base body with or from a first medium, wherein the first medium has the first refractive index. The second structural elements may be formed as cavities in the base body, wherein the cavities preferably form the second refractive index, for example by the refractive index of liquid, air or a gas which may be present as a medium in the cavities. The structural elements of the second type can be in particular formed as a, for example monolithic, base body with or from a second medium, wherein the second medium has the second refractive index. One or more of the monolithic base bodies of the first medium can be fused to one or more of the monolithic base bodies of the second medium prior to drawing and redrawing the fused base bodies to form a waveguide comprising a plurality of the first base bodies and a plurality of the second base bodies.

The cavities in the base body can be formed as filamentary channels, i.e. channels which, for example, have a significantly smaller cross-sectional area compared to the cross-sectional area of the waveguide, which can be introduced into the base body in particular with a laser beam of an ultrashort pulse laser. Furthermore, the filamentary channels in the base body can be reworked, in particular chemically or physically by etching processes, e.g. in order to smooth the contours of the filamentary channels.

In particular, in the case that the waveguide is formed as a base body with cavities, but also independently thereof, the waveguide may have a larger extension in cross-section than along the transport direction. In particular, the waveguide may be formed as a faceplate.

It may be provided that the waveguide has a cross-sectional area of 1.0 to 50 square centimeters.

The cross-sectional diameter of the waveguide may be at least 2 times greater than the length of the waveguide along the transport direction, at least 5 times greater, or at least 10 times greater.

A base body with cavities can be produced or manufactured in various ways. The cavities in the base body can be formed by additive construction of the base body, for example by means of 3D printing processes. Alternatively or additionally, cavities may be subtractively introduced into the base body, in particular as bores which are introduced into the base body in particular by abrasive material processing methods, for example mechanical drilling. Depending on the method used, bores are not exclusively limited to round geometries.

The waveguide may be manufactured in a multi-train process, in particular such that the waveguide comprises, in addition to the plurality of structural elements, at least a second plurality of structural elements, wherein the waveguide has, in cross-section, at least two surface regions which each comprise the cross-sectional regions of one of the two pluralities of structural elements and these may have an identical structure apart from a rotation and/or a reflection.

With regard to the length of the waveguide along the transport direction, it may be provided that the waveguide has a length along the transport direction of less than 10 millimeters, of less than 6 millimeters, or of less than 5 millimeters, especially if the waveguide is formed as a faceplate.

In general, however, it may also be provided that the waveguide has a length along the transport direction of at least 10 millimeters, of at least 20 millimeters, of at least 50 millimeters, or of at least 100 millimeters.

In the case that the waveguide is formed as a base body with cavities, the cavities in the base body, in particular the filamentary channels and/or the bores, may be filled with a second medium, the second medium having the second refractive index.

With regard to the materials, it may be provided that at least one structural element, in particular the or a first structural element, in particular the structural element formed as a base body, comprises or consists of one or more of the following materials as a medium: glass (including oxide and non-oxide materials such as chalcogenides), quartz glass, polymer, crystals, monocrystals, polycrystalline materials and/or glass ceramic.

Furthermore, at least one structural element, in particular the or a first structural element, in particular the structural element formed as a base body, may comprise or consist of a material as a medium which, in the wavelength range to be transmitted, esp. from 2 μm to 20 μm, in particular an attenuation of less than 100 dB/m, in particular of less than 50 dB/m, in particular of less than 10 dB/m, in particular of less than 1 dB/m, in particular an infrared-transmissive material, in particular a chalcogenide, in particular comprising at least one element from the group comprising oxygen, sulphur, selenium and tellurium, and at least one element from the group comprising arsenic, germanium, phosphorus, antimony, lead, boron, aluminum, gallium, indium, titanium, sodium.

Furthermore, optically active materials may be provided, e.g. as part of a medium or a filling and/or also as a layer or coating or other modification on the surfaces of an assembly of structural elements formed as rods or tubes. Thus, for example, a modification of the guided electromagnetic, e.g. in the sense of an amplification or conversion, can be achieved.

A further structural element, in particular the or a second structural element, may comprises or consists of the same or a different materials.

The first structural elements may be formed as, in particular, rod-shaped or tubular bodies with or made of a first medium, the first medium having the first refractive index.

The second structural elements can be formed as, in particular, rod-shaped or tubular bodies with or from a second medium, the second medium having the second refractive index, and/or as cavities in the first structural elements, the cavities forming the second refractive index or being filled with a second medium having the second refractive index.

In particular, in the case where the second structural elements can be present as filled cavities in the first structural elements, the structural elements may be formed as core-shell systems such that the core corresponds to the filled cavity.

Rod-shaped or tubular bodies are not to be understood exclusively as those with a round cross-sectional geometry.

The invention further relates to a method for producing a waveguide, in particular a waveguide having one or more of the features described herein, for transmitting electromagnetic waves from a proximal end of the waveguide to a distal end of the waveguide along a transport direction extending between the proximal and distal ends, the method comprising forming a fiber bundle that extends along the transport direction and comprises a first structural element and a second structural element that differs from the first structural element, whereby electromagnetic waves introduced into the proximal end are confined within a cross-sectional region transverse to the transport direction due to the difference between the first structural element and the second structural element, wherein the forming step comprises arranging the first structural element and the second structural element in the fiber bundle so that the fiber bundle has a curvature of 0.1 meters-1 or less.

In the following embodiments of the invention are described with reference to the Figures described. They show:

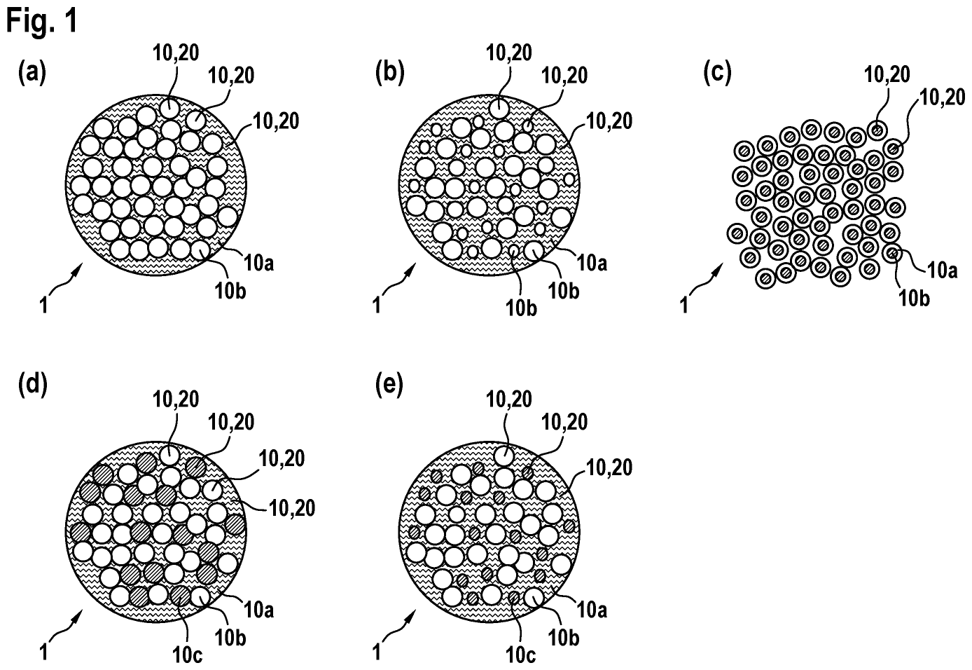

FIG. 1: Schematic illustration of cross-sections of various waveguides having (a), (b), (c) two types of structural elements and (d), (e) three types of structural elements, respectively, wherein the cross-sectional areas of the structural elements are arranged unevenly,

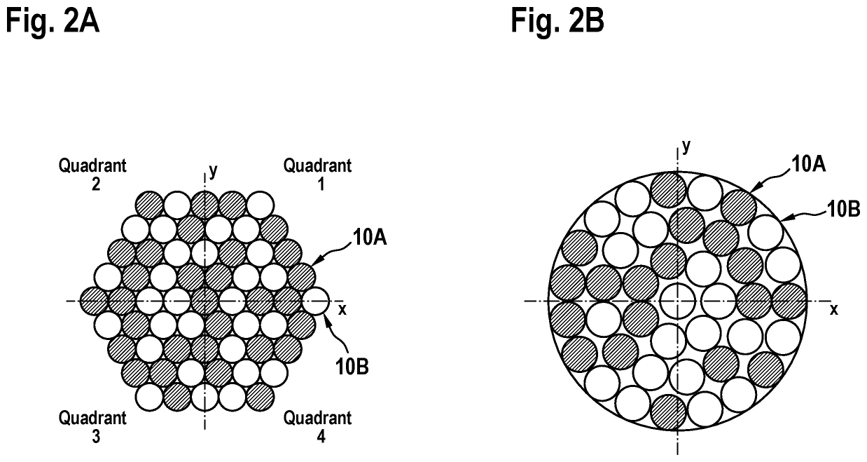

FIGS. 2A and 2B: Cross-sectional images of two glass fiber bundles,

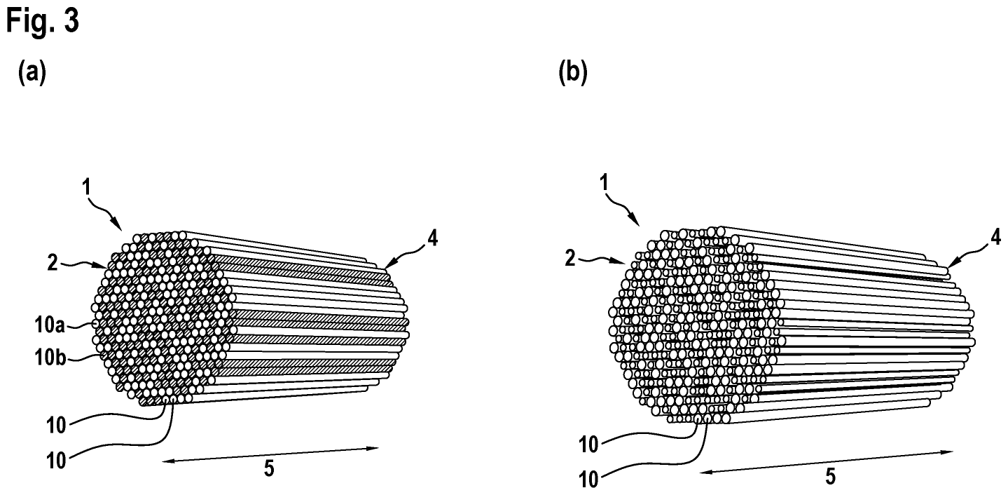

FIG. 3: Schematic perspective views of two waveguides having (a) two types of structural elements whose cross-sectional areas are non-uniformly distributed and (b) a plurality of structural elements of non-uniform refractive indices (plurality of types) and/or non-uniform geometries (diameters),

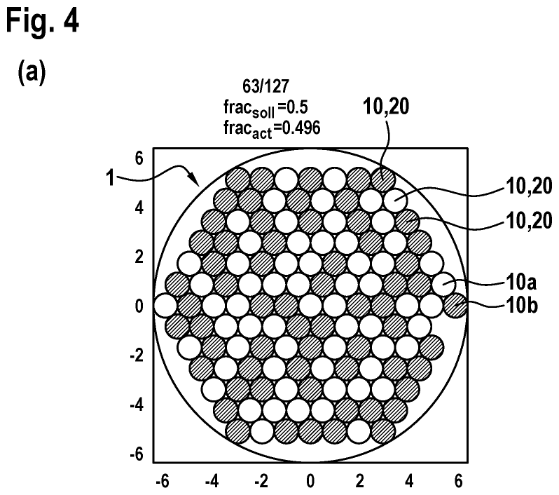

FIG. 4: Schematic cross-section of a waveguide with two types of structural elements whose cross-sectional areas are non-uniformly distributed on a hexagonal lattice,

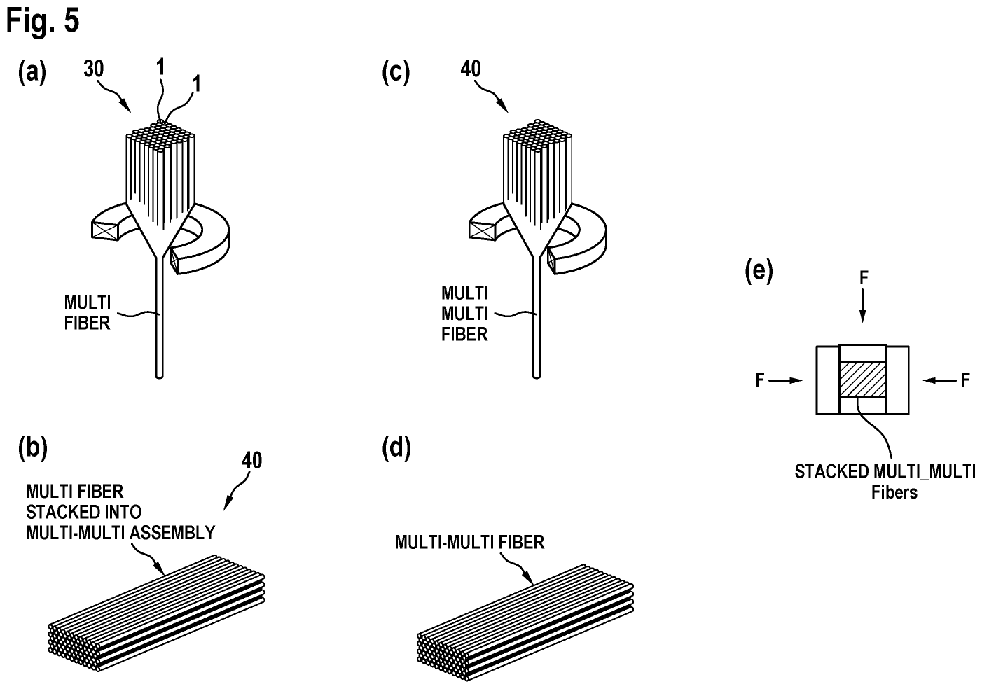

FIG. 5: Schematic perspective views of (a) waveguides assembled into a preform, which are drawn into length, (b), (c) waveguides assembled therefrom again into a preform, which are drawn into length, and (d) assembled again, and (e) waveguides fused under pressure,

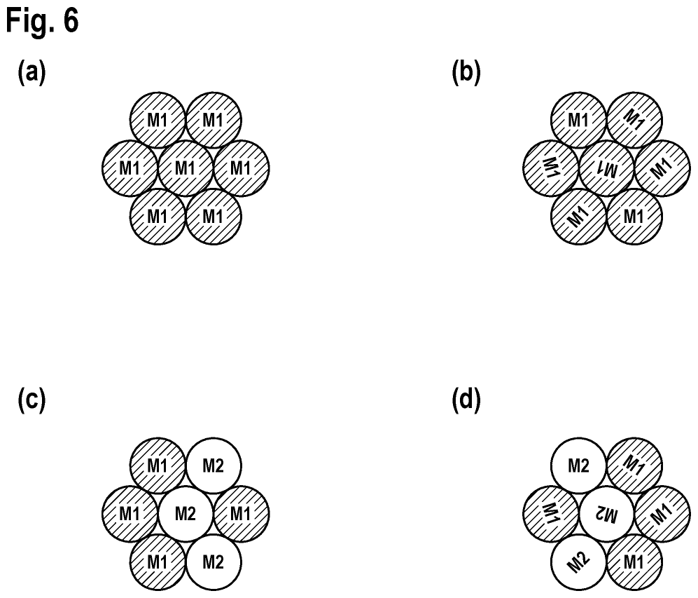

FIG. 6: Schematic cross-sections of the waveguides assembled in FIG. 5, again to form a preform, (a), (b) as sections from one waveguide drawn to length, (c), (d) as sections from two waveguides drawn to length, the waveguides (a), (c) being unrotated relative to one another, (b), (d) being rotated relative to one another,

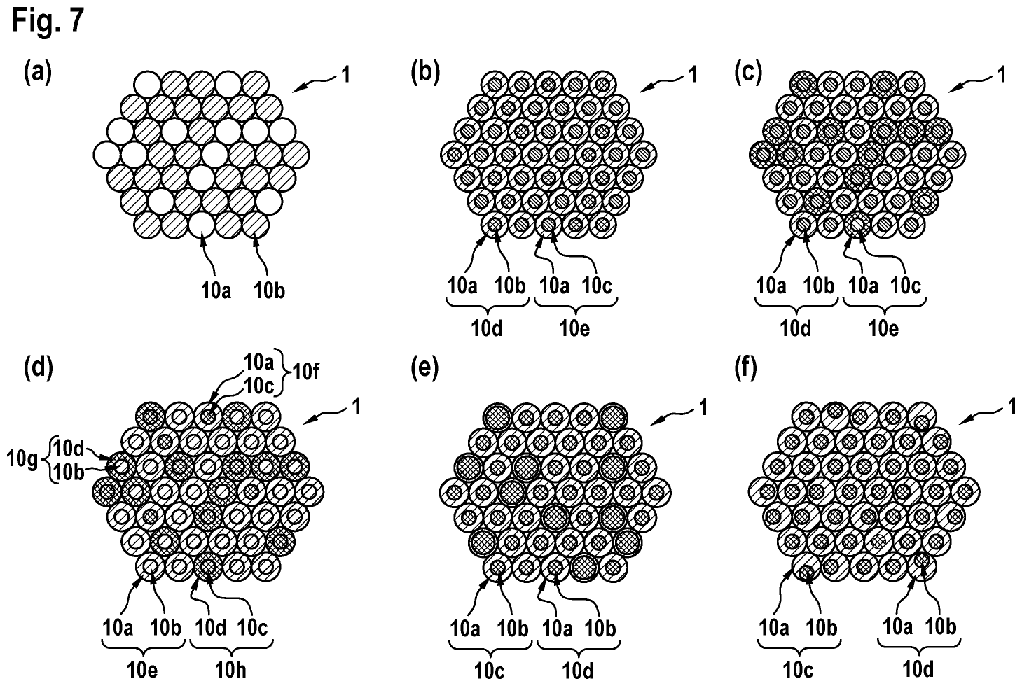

FIG. 7: Schematic illustration of various further possibilities for waveguides having structural elements or cross-sectional regions thereof which are formed unevenly but mathematically, the waveguides each comprising a plurality of structural elements of a first type and a plurality of structural elements of a second type,

FIG. 8: A photograph (and various enlarged sections) of a manufactured waveguide having a plurality of structural elements of a first type and a plurality of structural elements of a second type,

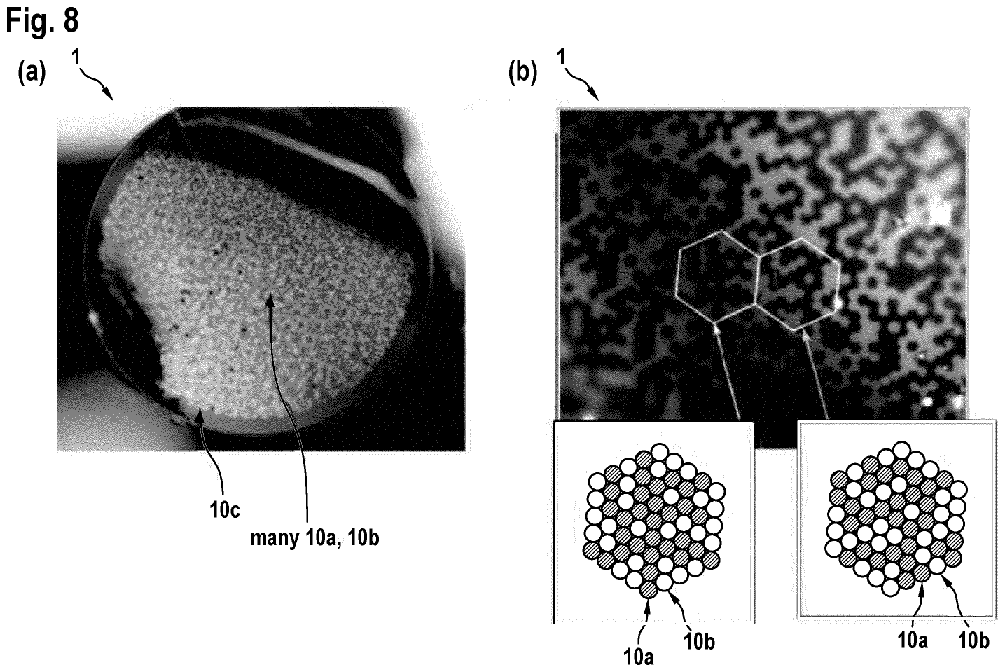

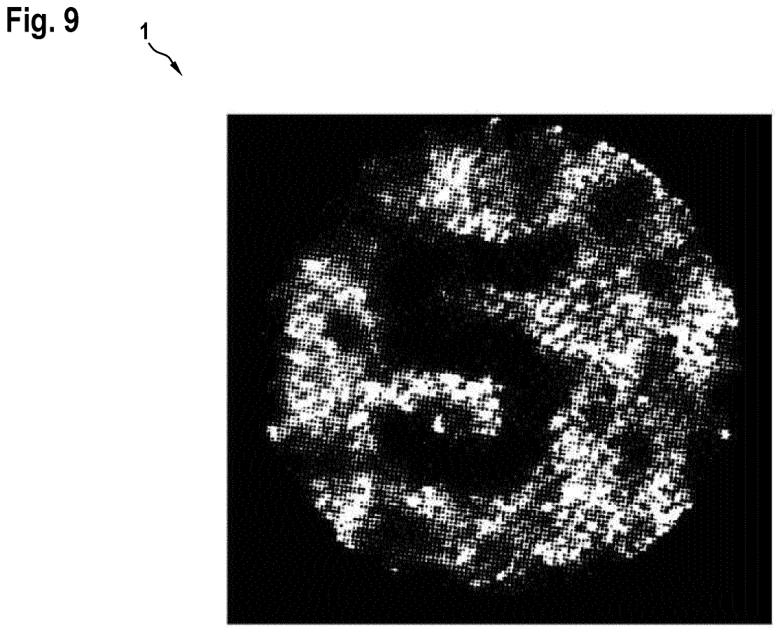

FIG. 9: A photograph of the waveguide of FIG. 8 in its application as an image guide.

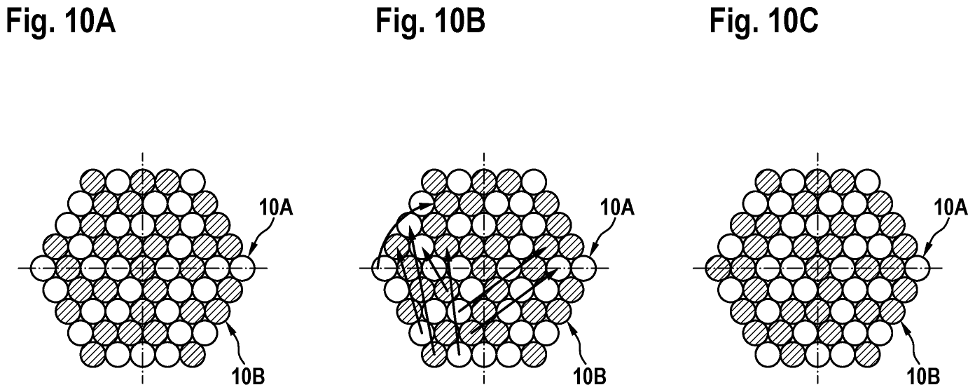

FIGS. 10A, 10B and 10C: The glass fiber bundles from example 1.

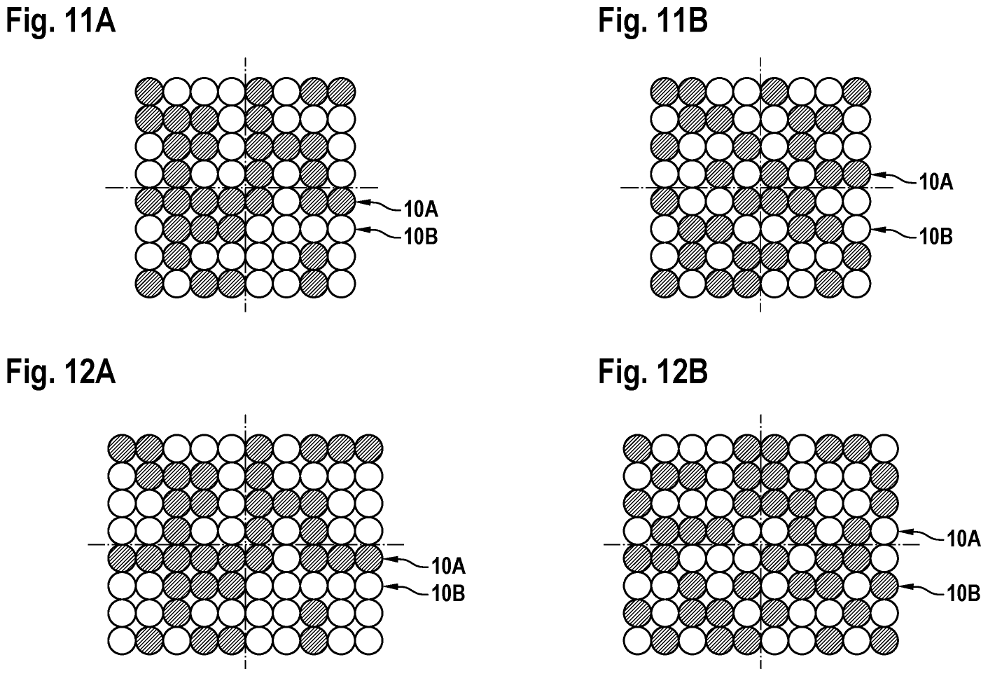

FIGS. 11A and 11B: The glass fiber bundles from example 2.

FIGS. 12A and 12B: The glass fiber bundles from example 3.

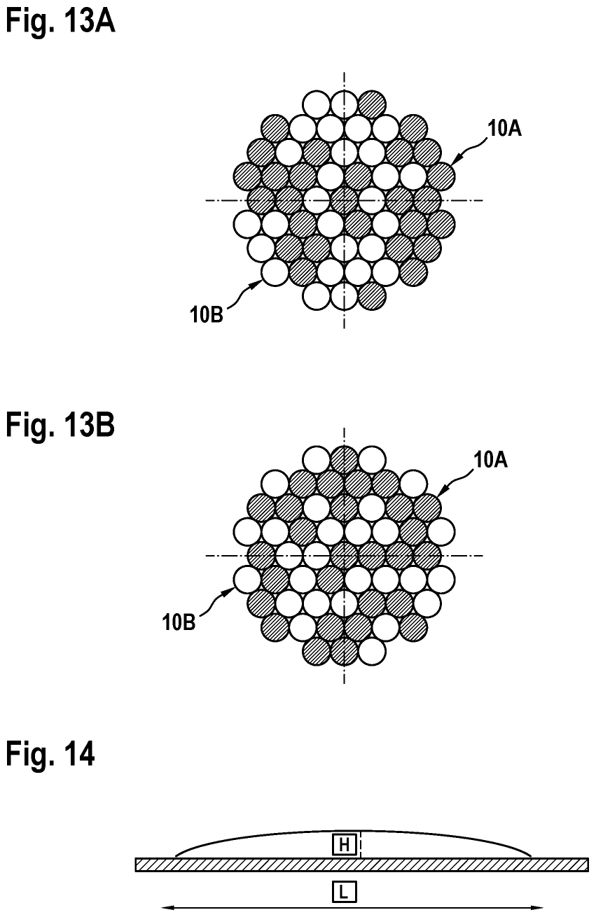

FIGS. 13A and 13B: The glass fiber bundles from example 4.

FIG. 14: Calculation of the curvature.

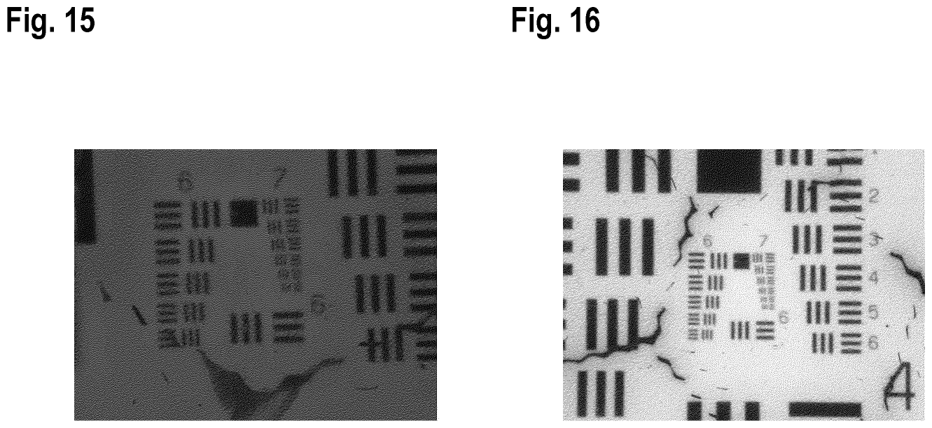

FIG. 15: The produced image from the glass fiber bundle shown in FIG. 10A.

FIG. 16: The produced image from the glass fiber bundle shown in FIG. 10C.

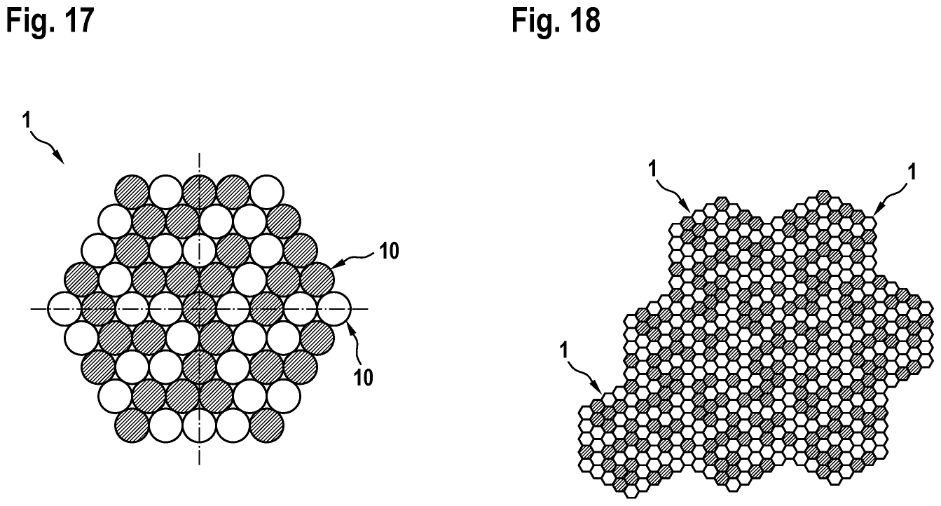

FIG. 17: Schematic illustration of a cross-section of a fiber bundle.

FIG. 18: Schematic illustration of a partial cross-section of a waveguide.

FIG. 1 shows various principal examples of waveguides (100) which can be used in particular as image guides. The waveguides (100) shown in cross-section each comprise a plurality of structural elements (10), each of which extends along the direction of transport of the waveguide (100), which is perpendicular to the figure here, and each of which extends proportionally over the cross-section thereof. Each of the structural elements (10) thus defines a cross-sectional region (20), i.e. a proportion of the area of the cross-section of the waveguide (100). The examples of waveguides shown each have at least two different types of structural elements, which differ in their refractive indices. These principle embodiments serve to illustrate some variants of non-uniformity and may deviate in detail from a deterministic positioning of structural elements determined according to the invention.

Such waveguides (100) for transmitting electromagnetic waves from a proximal end (2) of the waveguide (100) to a distal end (4) of the waveguide along a transport direction (5) extending between the proximal and distal end can comprise a fiber bundle (1) extending along the transport direction (5) and comprising a first structural element (10a) and a second structural element (10b) that differs from the first structural element (10a), whereby electromagnetic waves introduced into the proximal end (2) are confined within a cross-sectional region transverse to the transport direction (5) due to the difference between the first structural element (10a) and the second structural element (10b), wherein the fiber bundle (1) has a curvature of 0.1 meters-1 or less. As explained above, the curvature of the invention is a reduced amount of bowing compared to conventional Anderson localizing fiber bundles which may reduce the likelihood of noise, reduce the likelihood of mechanical failure, and increase the likelihood that the fiber bundles can be incorporated into a waveguide (100). See FIG. 17A for a depiction of the cross-section of a fiber bundle (1) composed of a plurality of first and second structural elements (10) and FIG. 17B for a depiction of a partial cross-section of a waveguide (100) composed of a plurality of fiber bundles (1).

As shown in FIG. 14, the curvature is measured by placing the fiber bundle on a flat surface, then measuring the length L of the fiber bundle along the image transport direction, then measuring the height H which is the distance between the midpoint of the fiber bundle and the axis that intersects the centers of the image input and image output ends of the fiber bundle, then calculating the radius of curvature R using the following formula. The curvature (units of meters-1) is the inverse of R:

$$Bending radius = R = \frac{4 {H}^{2} + {L}^{2}}{8 H} [ m ]$$

$$Curvature = \frac{1}{R}$$

In some embodiments, the curvature is 0.1 meters⁻¹ or less, 0.09 meters⁻¹ or less, 0.08 meters⁻¹ or less, 0.07 meters⁻¹ or less, 0.06 meters⁻¹ or less, 0.05 meters⁻¹ or less, 0.04 meters⁻¹ or less, 0.03 meters⁻¹ or less, 0.02 meters⁻¹ or less, 0.01 meters⁻¹ or less, and/or is more than 0 meters⁻¹.

The fiber bundle can have a Net CTE Modulus of 0.0100 ppm/K or less, 0.0075 ppm/K or less, 0.0050 ppm/K or less, 0.0025 ppm/K or less, and/or 0 m or more. One way to achieve the desirable curvature described herein is to manufacture the fiber bundle so that the fiber bundle has the Net CTE Modulus. The calculation of the Net CTE Modulus and ways to manufacture the fiber bundle to achieve the Net CTE Modulus are described herein.

The waveguide (100) shown in cross-section in FIG. 1 (a) has a first structural element 10a formed as a base body, which accommodates a plurality of second structural elements 10b. The second structural elements 10b may thereby be formed, for example, as cavities or hollow channels extending along the transport direction in the first structural element 10a. In this case, the first structural element 10a formed as a base body comprises a first material having a first refractive index, and the second structural elements 10b formed, for example, as cavities form the second refractive index, for example, by the air or another gas contained therein. In this case, the cross-sectional region 20 of the first structural element corresponds to the cross-sectional area of the waveguide (100) minus the holes in this area defined by the cavities, while the cross-sectional regions 20 of the second structural elements 10b each correspond to the cross-sectional area of the cavities. However, the cavities in the main body may also be filled with a second material, such that the second structural elements 10b correspond to the filled cavities. As schematically shown in the figure, the cross-sectional regions 20 of the second structural elements 10b are non-uniform in that their positions are non-uniformly distributed over the cross-section, in particular do not lie on a periodic grid. At the same time, however, the positions of the structural elements are mathematically determined as explained in more detail herein.

The waveguide (100) shown in cross-section in FIG. 1 (b) has two types 10a, 10b of structural elements, namely one structural element 10a formed as a base body and having a first refractive index and a plurality of structural elements 10b having a second refractive index different therefrom. In the example shown here, the cross-sectional regions 20 of the second structural elements 10b are not only non-uniformly arranged, but also have non-uniform geometries, in this case non-uniform diameters.

The waveguide (100) shown in cross-section in FIG. 1 (c) again has two types 10a, 10b of structural elements, wherein the cross-sectional regions of the second structural elements 10b are each arranged within a first structural element 10a, particularly as core-sheath systems. Thus, in this case, a plurality of first structural elements 10a and a plurality of second structural elements 10b are provided. The structural elements or their cross-sectional regions are formed non-uniformly in that the first structural elements 10a (which accommodate the second structural elements 10b) are arranged non-uniformly, in particular aperiodically, over the cross-section of the waveguide (100), this arrangement being mathematically determined.

The waveguides (100) shown in cross-section in FIGS. 1 (d) and (e) correspond in some aspects to the waveguides (100) shown in FIGS. 1 (a) and (b), respectively, but having structural elements of three types 10a, 10b, 10c having different refractive indices. In particular, cavities in the structural element 10a formed as a base body may be filled with different media. Accordingly, the structural elements 10b, 10c have in particular a non-uniformity in that their refractive index differs from each other.

The fiber bundle may be manufactured to have a curvature of 0.1 meters⁻¹ or less. One way to achieve this curvature is to manufacture the fiber bundle so that the fiber bundle has a Net CTE Modulus of 0.01 ppm/K or less.

The Net CTE Module is mathematically calculated as follows.

For a waveguide that is formed by combining a plurality of structural elements to form a fiber bundle and then combining a plurality of fiber bundles to form the waveguide, the calculation is made over the cross-section of a single fiber bundle, because that single fiber bundle is a repeating unit that forms the waveguide. For a waveguide that is formed by combining a plurality of structural elements to form the entire waveguide, without the intermediate steps of forming and combining together a plurality of fiber bundles, the calculation is made over the cross-section of the entire waveguide, because there is no single repeating unit of a fiber bundle. If the waveguide is formed by combining two or more different fiber bundles, then the calculation is individually made over the cross-section of each fiber bundle. In cases where it is not possible to identify the individual fiber bundles, for example when a manufactured waveguide is being analyzed to determine its properties, the calculation is made over the cross-section of the smallest recognizable repeating unit, and if there are two or more different recognizable repeating units, then the calculation is made over the cross-section of each of those repeating units.

The first step in the calculation is to take an actual image of a reference fiber bundle with a resolution of at least twenty pixels and bisect the cross-section along its two principle axes, in particular the horizontal x principal axis and the vertical y principal axis of the Cartesian coordinate system. The two principle axes are orthogonal to each other and are centered at the geometrical center of the fiber bundle, for example at the geometric center of a hexagonal-shaped cross-section as shown in FIG. 2A or at the geometric center of a circular-shaped cross-section as shown in FIG. 2B. FIGS. 2A and 2B show that this bisection creates four quadrants, wherein quadrant 1 is opposite quadrant 3 and quadrant 2 is opposite quadrant 4. For cross-sectional shapes that are not symmetrical like polygons or circles, a two principle axis bisection is still made at the geometric center to create four quadrants.

Next, the coordinates (0,0) are assigned to the geometric center, and the CTE along the x and y axes is calculated as follows:

$${α}_{X} = \sqrt{\frac{π}{{A}_{T}^{3}}} {\sum }_{k = 1}^{n} {\sum }_{l = 1}^{m} {A}_{k , l} {X}_{k , l} {α}_{k , l} [ ppm / K ]$$

$${α}_{Y} = \sqrt{\frac{π}{{A}_{T}^{3}}} {\sum }_{k = 1}^{n} {\sum }_{l = 1}^{m} {A}_{k , l} {Y}_{k , l} {α}_{k , l} [ ppm / K ]$$

A_{T}=number of pixels in the image of the fiber bundle
A_{k,l}=Area of one pixel
X_{k,l}=horizontal coordinate of each pixel with respect to the geometric center
Y_{k,l}=vertical coordinate of each pixel with respect to the geometric center
α_{k,l}=CTE of the pixel at the x,y coordinate
aₓ=CTE along the x axis
a_{y}=CTE along the y axis

The Net CTE Modulus is calculated as:

$$Net CTE Modulus = \sqrt{{α}_{X}^{2} + {α}_{Y}^{2}} [ ppm / K ]$$

If the Net CTE Modulus is not 0.01 ppm/K or less, this is an indication that the fiber bundle might not have a desirable curvature of 0.1 meters⁻¹ or less. In order to achieve this desirable curvature for the next fiber bundle to be manufactured, the location of each structural element in the next fiber bundle to be manufactured might need to be rearranged in relation to its neighboring structural elements so that the resulting Net CTE Modulus for the newly manufactured fiber bundle will be 0.01 ppm/K or less. For example, this relocation could be that the location of one or more of the first and second structural elements, and thus their x and y coordinates, is moved in relation to the other structural elements, so that when the Net CTE Modulus calculation is made for the new fiber bundle, the new fiber bundle will have a Net CTE Modulus of 0.01 ppm/K or less, and thus the new fiber bundle will be likely to have a curvature of 0.1 meters-1 or less. This rearrangement/relocation of the location of the first and second structural materials is performed multiple times if needed until a Net CTE Modulus of 0.01 ppm/K or less is achieved.

One possible way to realize which optical structural elements should be rearranged is to consider the sign and the magnitude of the aₓ and the a_{y}. For example, 1) a positive sign for aₓ and a positive sign for a_{y} means that the structural elements in the first quadrant have an excess of the higher expansion structural elements, and that a certain number of the high expansion structural elements from the first quadrant should be replaced with an equal number of the low expansion structural elements from the opposite third quadrant; 2) a negative sign for aₓ and a positive sign for a_{y} means that the structural elements in the second quadrant have an excess of the higher expansion structural elements, and that a certain number of the high expansion structural elements from the second quadrant should be replaced with an equal number of the low expansion structural elements from the opposite fourth quadrant; 3) a negative sign for aₓ and a negative sign for a_{y} means that the structural elements in the third quadrant have an excess of the higher expansion structural elements, and that a certain number of the high expansion structural elements from the third quadrant should be replaced with an equal number of the low expansion structural elements from the opposite first quadrant; and 4) a positive sign for aₓ and a negative sign for a_{y} means that the structural elements in the fourth quadrant have an excess of the higher expansion structural elements, and that a certain number of the high expansion structural elements from the fourth quadrant should be replaced with an equal number of the low expansion structural elements from the opposite second quadrant.

In addition to or as an alternative to making the replacement between opposite quadrants, the replacement can be made between adjacent quadrants. Also, the replacement can be made within the same quadrant by moving the high expansion structural elements closer to the 0,0 coordinate, but this may lead to an agglomeration of high expansion structural elements and partial symmetry. Still further, during any of these replacements, other high and low thermal expansion structural elements may need to be relocated to avoid creating an ordered pattern with symmetry that is not conducive for Anderson localization.

This replacement of high thermal expansion structural elements with low thermal expansion structural elements can be done until a desirable New CTE Modulus is achieved, such as 0.015 m or less.

FIG. 3 shows two further examples of waveguides (100) which can be used in particular as image guides. The waveguides (100) comprise a plurality of first and second structural elements 10, each of which extends from a proximal end 2 to a distal end 4 of the waveguide (100) along the transport direction 5 and is, for example, rod-shaped.

The waveguide (100) shown in FIG. 3 (a) has a plurality of first structural elements 10a and a plurality of second structural elements 10b. The structural elements have a non-uniform arrangement in that the first structural elements 10a and the second structural elements 10b are non-uniformly arranged and/or distributed, the arrangement and/or distribution should be mathematically determined as described herein to achieve the desired Net CTE Modulus and therefore the desired curvature, although FIG. 3 does not necessarily show an arrangement that achieves a desired Net CTE Modulus or curvature.

The waveguide (100) shown in FIG. 3 (b) comprises a plurality of structural elements 10, wherein in this example the cross-sectional regions of the structural elements have non-uniform geometries. In particular, the geometries may differ in that the diameters of the structural elements or their cross-sectional regions differ from each other. Furthermore, the structural elements 10 in each of FIGS. 3 (a) and 3 (b) may exhibit a non-uniformity in that the refractive indices of the structural elements differ from one another. In this respect, a discrete number of different refractive indices, for example two, three, four, etc. may be provided.

FIG. 4 shows a cross-section of a fiber bundle (1) which corresponds in some aspects to the waveguide (100) shown in FIG. 3 (a). The fiber bundle (1) shown in FIG. 4 has a plurality of, in particular rod-shaped, structural elements 10, namely a plurality of a first structural elements 10a and a plurality of a second structural elements 10b, the structural elements 10 being arranged in cross-section on a hexagonal lattice. At least one of the structural elements 10, or its cross-sectional area 20, is equidistant from, and preferably adjacent to, six immediately adjacent structural elements 10, or their cross-sectional areas 20.

FIG. 5 shows steps of a method of manufacturing a waveguide according to a multi-draw method. In this process, a plurality of waveguides are assembled to form a preform 30 and drawn into length (FIG. 5a). The waveguides may be, for example, an arrangement of structural elements 10, 20 or, 10a, b, for example, according to FIG. 4, or alternative arrangements, for example, according to those shown in FIG. 1 (a) to (e), which may be already drawn out in a known manner. Ideally the structural elements are positioned in relation to each other to achieve the desired Net CTE Modulus.

The assembled and elongated waveguides (“multi-fiber”) are then disassembled into sections and again assembled into a preform 40 (FIG. 5b, “multi-multi-assembly”). The preform 40 can then again be drawn to length (FIG. 5c), and if necessary again broken down into sections and assembled (FIG. 5d). Finally, the assembly thus obtained can be fused by applying heat and/or pressure, and in particular under vacuum (FIG. 5e).

With reference to FIG. 6, the assembled fiber bundles (“Multi-Fiber”, here “M1”) drawn to length can be assembled unrotated relative to one another (FIG. 6a) or rotated relative to one another (FIG. 6b) during assembly into a further preform. Furthermore, during the assembly, sections from at least two different assembled fiber bundles (“M1”, “M2”) drawn into length can be assembled unrotated (FIG. 6c) or rotated relative to one another (FIG. 6d). Analogous to the arrangements shown in FIGS. 6a and 6b, the fiber bundles can also be or are arranged unrotated or rotated relative to one another when the first preform is assembled.

With reference to FIG. 7, various embodiments of the non-uniformity of the structural elements will be discussed again below by way of example. As described, the structural elements, in particular their cross-sectional regions, are characterized on the one hand by a non-uniformity in relation to one another, and on the other hand by a regularity to the effect that the non-uniformity of the structural elements is predetermined to achieve a desired Net CTE Modulus.

FIG. 7 shows some fiber bundles (1), each with a plurality of structural elements of a first type and a plurality of structural elements of a second type (and sometimes further types in FIG. 7d). In particular, the fiber bundles (1) shown here do not have any matrix material, rather the structural elements are neighboring each other. The fiber bundles (1) shown in FIG. 7 have in common that the structural elements of the different types, in particular their cross-sectional regions, are periodically positioned to achieve a desired Net CTE Modulus.

FIG. 7a shows approximately a fiber bundle (1) having a plurality of structural elements 10a and a plurality of structural elements 10b having different refractive indices.

FIG. 7b shows a fiber bundle (1) having a plurality of structural elements 10d and a plurality of structural elements 10e, which have different refractive indices and a different substructure, the substructure being defined by sub-structural elements 10a and 10b (having refractive indices a and b) and 10a and 10c (having refractive indices a and c), respectively. The substructure here is that the structural elements 10d and 10e are formed as core-shell systems, with the cores being different.

FIG. 7c similarly shows a fiber bundle (1) having a plurality of structural elements 10d and a plurality of structural elements 10e, which have different refractive indices and a different substructure, the substructure being defined by the sub-structural elements 10a and 10b (having refractive indices a and b) and 10c and 10b (having refractive indices c and b), respectively. The substructure here is that the structural elements 10d and 10e are formed as core-cladding systems, with the claddings differing.

FIG. 7d similarly shows a fiber bundle (1) having a plurality of structural elements 10e, a plurality of structural elements 10f, a plurality of structural elements 10g, and a plurality of structural elements 10h, which have different refractive indices and a different substructure, wherein the substructure is represented by the sub-structural elements 10a and 10b (having refractive indices a and b), resp. 10a and 10c (having refractive indices a and c) and 10b and 10d (having refractive indices b and d) and 10c and 10d (having refractive indices c and d), respectively. The substructure here is that the structural elements 10e, 10f, 10g and 10h are formed as core-shell systems, with both the shells and the cores being different.

FIG. 7e shows a fiber bundle (1) having a plurality of structural elements 10c and a plurality of structural elements 10d having different geometries and a different substructure, wherein the substructure of the structural element 10c is defined by the substructural elements 10a and 10b (having refractive indices a and b and a first core diameter), and the substructure of the structural element 10d is defined by the substructural elements 10a and 10b (having refractive indices a and b and a second core diameter).

FIG. 7f shows a fiber bundle (1) having a plurality of structural elements 10c and a plurality of structural elements 10d, which have different geometries and a different substructure, wherein the substructure of the structural element 10c is defined by the substructural elements 10a and 10b (having refractive indices a and b and a centrally positioned core), and the substructure of the structural element 10d is defined by the substructural elements 10a and 10b (having refractive indices a and b and an eccentrically positioned core).

FIG. 8a shows a photograph as an example of a fiber bundle (1) having a plurality of fibers with a first refractive index as the first structural elements 10a and a plurality of fibers with a second refractive index as second structural elements 10b, and an enlarged view and sketches thereof in

FIG. 8b. In this case, the fibers of the structural elements 10a and 10b are adjacent to each other and are positioned and the Net CTE Modulus can be calculated. The structural elements of the first type 10a and of the second type 10b may be surrounded by a structural element of a third type 10c formed as a cladding tube. The cladding tube may have a refractive index which is lower than both the refractive index of the structural elements of the first type 10a and the refractive index of the second type 10b.

FIG. 9 shows a photograph of the fiber bundle (1) of FIG. 8a in its application as an image guide, transmitting an image showing the numeral 5. Due to the non-uniformity in the arrangement of the structural elements, an image transmission with a high resolution based on the phenomenon of transverse Anderson localization is achieved here.

In summary, a waveguide (100) may be provided for transmitting electromagnetic waves from a proximal end (2) of the waveguide (100) to a distal end (4) of the waveguide (100) along a transport direction (5) extending between the proximal and distal ends. The waveguide (100) may have a fiber bundle (1) extending along the transport direction (5) and having a first structural element (10a) and a second structural element (10b) that differs from the first structural element (10a). Electromagnetic waves introduced into the proximal end (2) may be confined within a cross-sectional region transverse to the transport direction (5) due to the difference between the first structural element (10a) and the second structural element (10b). The fiber bundle (1) can have a Net CTE Modulus of 0.01 ppm/K or less and a curvature of 0.1 meters⁻¹ or less.

The CTE of the first structural element (10a) can differ from the CTE of the second structural element (10b) by 5 ppm/K or less, or by 3,690 ppm/K or less when one of the structural elements is a cavity filled with air.

The fiber bundle (1) can comprise a plurality of first structural elements (10a) and a plurality of second structural elements (10b) and the waveguide (100) can comprise a plurality of fiber bundles (1). The total number of first structural elements (10a) and second structural elements (10b) in the fiber bundle (1) can be enough to produce a centered polygonal unit, for example a fiber bundle having 20 to 300 structural elements or 50 to 300 structural elements, such as for example sixty one structural elements as shown in FIG. 2.

One or more of the first structural elements (10a) can be fused to one or more of the second structural elements (10b). The second structural element (10b) can be an air channel located within a matrix formed from the first structural element (10a). Each individual first structural element (10a) and each individual second structural element (10b) do not need to be surrounded by a cladding.

A plurality of the first structural elements (10a) and a plurality of the second structural elements (10b) can be non-uniformly arranged when viewed in a cross-section of the fiber bundle (1). The first structural element (10a) and the second structural element (10b) can have identical compositions but different diameters when viewed in a cross-section of the fiber bundle (1).

A method of manufacturing a waveguide (100) for transmitting electromagnetic waves from a proximal end (2) of the waveguide (100) to a distal end (4) of the waveguide (100) along a transport direction (5) extending between the proximal and distal ends can comprise the steps of determining the intended curvature of the waveguide (100) and manufacturing the waveguide (100) to achieve the intended curvature. The method can comprise the steps of forming a fiber bundle (1) that extends along the transport direction (5) and comprises a first structural element (10a) and a second structural element (10b) that differs from the first structural element (10a), whereby electromagnetic waves introduced into the proximal end (2) are confined within a cross-sectional region transverse to the transport direction (5) due to the difference between the first structural element (10a) and the second structural element (10b), and wherein the forming step comprises arranging the first structural element (10a) and the second structural element (10b) in the fiber bundle (1) so that the fiber bundle (1) has a curvature of 0.1 meters⁻¹ or less.

### EXAMPLES

The following waveguides were prepared and analyzed.

### Example 1

A glass fiber bundle was prepared having multiple first structural elements with a CTE of 5 ppm/K and multiple second structural elements having a CTE of 7.3 ppm/K. The location of each of the structural elements was arbitrarily positioned as shown in FIG. 10A (the first structural elements are shown as lined and the second structural elements are shown as squiggled). The Net CTE Modulus was 0.0383 ppm/K. The curvature was 0.083 meters⁻¹. The produced image is shown in FIG. 15.

The first glass fiber bundle had an aₓ of −0.0171 ppm/K and an a_{y} of −0.342 ppm/K which means that there was an excess of high expansion fibers in the third quadrant. To decrease the Net CTE Modulus and to decrease the curvature, several structural elements from the third quadrant were relocated to the first and second quadrants as shown in FIG. 10B to produce a second glass fiber bundle as shown in FIG. 10C having an aₓ of −0.0043 ppm/K and an a_{y} of −0.0086 ppm/K and thus a Net CTE Modulus of 0.0096 ppm/K. The curvature was between 0 and 0.01 meters⁻¹. The produced image is shown in FIG. 16.

### Example 2

The first and second structural elements from example 1 were arranged in the manner shown in FIG. 11A. The Net CTE Modulus was 0.1213 ppm/K.

The first glass fiber bundle had an aₓ of 0.1115 ppm/K and an a_{y} of −0.0478 ppm/K which means that there was an excess of high expansion fibers in the fourth quadrant. To decrease the Net CTE Modulus and to decrease the curvature, several structural elements from the fourth quadrant were relocated to the second and third quadrants to produce a second glass fiber bundle as shown in FIG. 11B having an aₓ of 0 ppm/K and an a_{y} of 0 ppm/K and thus a Net CTE Modulus of 0 ppm/K.

### Example 3

The first and second structural elements from example 1 were arranged in the manner shown in FIG. 12A. The Net CTE Modulus was 0.1051 ppm/K.

The first glass fiber bundle had an aₓ of 0.0798 ppm/K and an a_{y} of −0.0684 ppm/K which means that there was an excess of high expansion fibers in the fourth quadrant. To decrease the Net CTE Modulus and to decrease the curvature, several structural elements from the fourth quadrant were relocated to the second and first quadrants to produce a second glass fiber bundle as shown in FIG. 12B having an aₓ of 0 ppm/K and an a_{y} of 0 ppm/K and thus a Net CTE Modulus of 0 ppm/K.

### Example 4

The first and second structural elements from example 1 were arranged in the manner shown in FIG. 13A. The Net CTE Modulus was 0.0756 ppm/K.

The first glass fiber bundle had an aₓ of 0.0750 ppm/K and an a_{y} of 0.0100 ppm/K which means that there was an excess of high expansion fibers in the first quadrant. To decrease the Net CTE Modulus and to decrease the curvature, several structural elements from the first quadrant were relocated to the third and fourth quadrants to produce a second glass fiber bundle as shown in FIG. 13B having an aₓ of 0 ppm/K and an a_{y} of 0 ppm/K and thus a Net CTE Modulus of 0 ppm/K.

1. A waveguide for transmitting electromagnetic waves from a proximal end of the waveguide to a distal end of the waveguide along a transport direction extending between the proximal and distal ends comprising:
a fiber bundle extending along the transport direction and comprising a disordered arrangement of a first structural element and a second structural element that differs from the first structural element, whereby electromagnetic waves introduced into the proximal end are confined within a cross-sectional region transverse to the transport direction due to the difference between the first structural element and the second structural element,
wherein the fiber bundle has a curvature of 0.1 meters-¹ or less.

2. The waveguide according to claim 1, wherein the fiber bundle has the curvature is 0.1 to more than 0 meters-¹.

3. The waveguide according to claim 1, wherein the fiber bundle has a Net CTE Modulus of 0.01 ppm/K or less.

4. The waveguide according to claim 1, wherein the fiber bundle has a Net CTE Modulus of O to 0.01 ppm/K.

5. The waveguide according to claim 1, wherein a CTE of the first structural element differs from a CTE of the second structural element by 5 ppm/K or less.

6. The waveguide according to claim 1, wherein the fiber bundle comprises a plurality of first structural elements and a plurality of second structural elements.

7. The waveguide according to claim 6, wherein the waveguide comprises a plurality of fiber bundles.

8. The waveguide according to claim 6, wherein the fiber bundle comprises a total number of first structural elements and a plurality of second structural elements of 20 to 300.

9. The waveguide according to claim 1, wherein one or more of the first structural elements are fused to one or more of the second structural elements.

10. The waveguide according to claim 1, wherein the second structural element is an air channel located within a matrix formed from the first structural element.

11. The waveguide according to claim 1, wherein each individual first structural element and each individual second structural element is not surrounded by a cladding.

12. The waveguide according to claim 1, wherein a plurality of the first structural elements and a plurality of the second structural elements are non-uniformly arranged when viewed in a cross-section of the fiber bundle.

13. A method of manufacturing a waveguide for transmitting electromagnetic waves from a proximal end of the waveguide to a distal end of the waveguide along a transport direction extending between the proximal and distal ends, comprising:
determining an intended curvature of the waveguide; and
manufacturing the waveguide to achieve the intended curvature.

14. A method of manufacturing a waveguide for transmitting electromagnetic waves from a proximal end of the waveguide to a distal end of the waveguide along a transport direction extending between the proximal and distal ends, comprising:
forming a fiber bundle that extends along the transport direction and comprises a first structural element and a second structural element that differs from the first structural element, whereby electromagnetic waves introduced into the proximal end are confined within a cross-sectional region transverse to the transport direction due to the difference between the first structural element and the second structural element, wherein the forming step comprises arranging the first structural element and the second structural element in the fiber bundle so that the fiber bundle has a curvature of 0.1 meters-¹ or less.
